(19) United States
(12) Patent Application Publication
(10) Pub. No.: US 2004/0115246 A1
(43) Pub. Date: Jun. 17, 2004

(54) Animal feed composition, use thereof, and animal feed product comprising same

(76) Inventor: Laurent Locatelli, Morteau (FR)

Correspondence Address: DOWELL & DOWELL PC, SUITE 309, 1215 JEFFERSON DAVIS HIGHWAY, ARLINGTON, VA, 22202

(21) Appl. No.: 10/471,001

(22) PCT Filed: Mar. 7, 2002
(86) PCT No.: PCT/FR02/00827

(30) Foreign Application Priority Data
Mar. 8, 2001 (FR) 01/03186

(51) Int. Cl. A23K 1/165; A23K 1/17; A23L 1/164

(52) U.S. Cl. 424/442; 426/620

(57) ABSTRACT

The invention concerns an animal food composition designed to coat domestic animal feedstuffs, consisting of an emulsion comprising a primary mixture and a thickening agent. Said primary mixture can be oil or water, or a dairy product.

The present invention relates to an animal feed composition, a use of this composition, and an animal feed product comprising this composition.

The invention covers more particularly domestic animal feedstuffs of the dry type, that is to say whose moisture content is less than or equal to 14%.

Such dry feedstuffs, which are supposed to cover all the nutritional needs of the animal, have nevertheless certain disadvantages. Indeed, it has been observed that, although their composition offers a degree of dietary balance to domestic animals, the latter are not sufficiently attracted by these feedstuffs, in terms of taste, such that they do not consume them with pleasure.

The invention proposes to remedy this disadvantage.

To this effect, its subject is an animal feed composition designed to coat dry domestic animal feedstuffs, this composition consisting of an emulsion comprising a primary mixture and a thickening agent.

Advantageously, the primary mixture comprises water and a dietary oil, this composition additionally comprising an emulsifying agent.

The abovementioned emulsion is advantageously of the oil-in-water type, namely that it is made by mixing, with water, a smaller quantity of dietary oil, which is thus dispersed in the water, the latter forming the continuous phase of the emulsion.

Advantageously, the composition comprises the following proportions, expressed by weight:

between 50 and 85% of water, preferably between 70 and 80%;

between 10 and 40% of dietary oil, preferably between 20 and 30%;

between 0.1 and 5% of thickening agent, preferably between 0.2 and 3%; and

between 0.1 and 5% of emulsifying agent, preferably between 0.2 and 3%.

According to an advantageous characteristic of the invention, the dietary oil is a rapeseed oil. The latter is of significant interest, in terms of cost.

Moreover, this rapeseed oil has a satisfactory nutritional quality. As a variant, it is possible to envisage using a sunflower oil.

According to another variant embodiment of the invention, the primary mixture is a milk-based product, such as in particular milk, optionally concentrated, or alternatively butter.

According to another advantageous characteristic of the invention, the animal feed composition has, at room temperature, a viscosity of between 2 000 and 10 000 centipoises, preferably between 2 500 and 3 500 centipoises.

Such a range of viscosities confers on the composition of the invention a relatively slow flow. Thus, it exists in a thick form, while being liquid.

The thickener may be of the xanthan type, or it may be composed of a mixture of gum acacia and xanthan gum. Such a thickener is for example marketed by the company CNI under the reference THIXOGUM. The thickener may also be CARRAGEENAN.

The emulsifier is for example of the lecithin or monoglyceride type. It is in particular the product marketed by the company STERN under the reference STERNVITAL, or alternatively the product marketed by the company LUCAS MEYER SA under the reference EMULTOP. This emulisifier may also be trisodium orthophosphate.

According to another advantageous characteristic of the invention, the animal feed composition contains a preservative, which is present in proportions of between 0.05 and 1% by weight, preferably between 0.1 and 0.5%. This preservative is for example of the potassium sorbate type.

Advantageously, the feed composition may additionally comprise salt, which is present in proportions of between 0.1 and 2% by weight, preferably between 0.3 and 1.5%, and sucrose, which is present in proportions of between 0.1 and 2% by weight, preferably between 0.3 and 1.5%.

Moreover, the animal feed composition of the invention advantageously comprises a flavoring agent, which is present in proportions of between 0.05% and 1.5% by weight, preferably between 0.2 and 1%.

It is for example one of the products marketed by the company FIS, which make it possible to give the composition flavors respectively of rare beef, roast beef, tuna, fish or alternatively shellfish.

As a variant, the flavoring agent may comprise pheromones, or alternatively essential oils.

According to another advantageous characteristic of the invention, the composition additionally comprises a taste enhancer, which is present in proportions of between 0.1 and 3%, preferably between 0.3 and 2% by weight.

Such a taste enhancer is for example a yeast marketed by the company BIOSPRINGER.

The composition of the invention may also contain homogenizers, such as colloids. It advantageously has a low pH, for example of less than 6, for optimum preservation.

The subject of the invention is also a process for manufacturing the animal feed composition, as defined above, characterized in that it comprises a phase of mixing, with water, thickening agent and emulsifying agent and, optionally, preservative, salt, sucrose and flavoring agent, and then a phase for adding dietary oil to the aqueous mixture thus formed, and a phase for homogenizing this oil and this aqueous mixture, so as to form the emulsion.

The mixing and homogenizing phases are for example carried out for a period of thirty seconds to one minute.

As a variant, the composition of the invention may be prepared from a concentrated solution, to which water is added.

It is also possible to prepare the composition of the invention from a lyophilized substance.

It is also possible to envisage placing the composition in spray cans, so that it can be distributed by spraying.

The subject of the invention is also a use of the composition, as defined above, for coating dry domestic animal feedstuffs.

The expression dry feedstuffs is understood to mean feedstuffs whose moisture content is less than 14%, for example biscuits.

The subject of the invention is finally an animal feed product, in kit form, comprising the animal feed composition, as defined above, contained in a first container, and dry domestic animal feedstuffs, contained in a second container.

The invention makes it possible to achieve the objectives previously mentioned.

The use of the animal feed composition in accordance with the invention consists in coating dry feedstuffs, such as biscuits, using this composition, of the emulsion type.

To this effect, the owner of the animal can buy, on the one hand, dry feedstuffs in their traditional packaging and, on the other hand, the composition of the invention contained in an independent container.

It is observed that, once this operation of coating the dry feedstuffs has been carried out, the latter become more attractive both from a taste and olfactory point of view.

Thus, the appetite of the domestic animals for which such dry feedstuffs are provided is substantially increased by virtue of the composition of the invention. The health of these animals is therefore preserved accordingly.

Moreover, given that it consists of an oil-in-water type emulsion, the composition of the invention does not cause significant softening of the dry feedstuffs. This makes it possible to preserve their crunchy character.

Using a feed composition in which the quantity of oil is less than the quantity of water is advantageous in terms of calorific value.

Moreover, the use of this dietary oil makes it possible to provide the animals with unsaturated fatty acids, such as oleic acid and linoleic acid. This is advantageous in particular in that the ingestion of these fatty acids brings about an improvement in the esthetic appearance of the fur of the animals.

In addition, the composition of the invention is easy to preserve, for a long period, with no difficult storage conditions. This composition has a nice appearance for the owners of the animals, both from the olfactory and visual points of view.

Two exemplary embodiments of the animal feed composition in accordance with the invention will now be described in the text that follows.

### EXAMPLE 1

The following components are added to 750 ml of water,

10 g of thickener marketed by the company CNI under the reference THYXOGUM;

10 g of sucrose;

8 g of common salt;

5 g of the emulsifier marketed by the company LUCAS MEYER SA under the reference EMULTOP;

1 g of potassium sorbate; and

10 g of flavoring agent, beef flavor, marketed by the company FIS under the reference 1.23.21L-XL.

The whole is mixed for thirty seconds, in order to obtain an aqueous mixture.

250 ml of rapeseed oil are then added to this aqueous mixture. The whole is homogenized for 30 seconds in order to obtain an oil-in-water emulsion, forming an animal feed composition.

This composition is more particularly designed for dogs because of the presence of beef flavor flavoring agent.

### EXAMPLE 2

The following components are added to 750 ml of water:

10 g of thickener marketed by the company CNI under the reference THYXOGUM;

10 g of sucrose;

8 g of common salt;

5 g of the emulsifier marketed by the company LUCAS MEYER SA under the reference EMULTOP;

1 g of potassium sorbate; and

5 g of flavoring agent, cod flavor, marketed by the company FIS under the reference 5.51.211-XL.

The whole is mixed for thirty seconds, in order to obtain an aqueous mixture.

250 ml of rapeseed oil are then added to this aqueous mixture. The whole is homogenized for 30 seconds in order to obtain an oil-in-water emulsion, forming an animal feed composition.

This composition is more particularly designed for the feline breed because of the presence of cod flavor.

1. An animal feed composition designed to coat dry domestic animal feedstuffs, this composition consisting of an emulsion comprising a primary mixture and a thickening agent.

2. The composition as claimed in claim 1, characterized in that the primary mixture comprises water and a dietary oil, this composition additionally comprising an emulsifying agent.

3. The composition as claimed in claim 2, characterized in that it comprises the following proportions, expressed by weight:
between 50 and 85% of water, preferably between 70 and 80%;
between 10 and 40% of dietary oil, preferably between 20 and 30%;
between 0.1 and 5% of thickening agent, preferably between 0.2 and 3%; and
between 0.1 and 5% of emulsifying agent, preferably between 0.2 and 3%.

4. The composition as claimed in claim 1, characterized in that the primary mixture is a milk-based product.

5. The composition as claimed in any one of the preceding claims, characterized in that it has, at room temperature, a viscosity of between 2 000 and 10 000 centipoises, preferably between 2 500 and 3 500 centipoises.

6. The composition as claimed in any one of the preceding claims, characterized in that it contains a preservative, which is present in proportions of between 0.05 and 1% by weight, preferably between 0.1 and 0.5%.

7. The composition as claimed in any one of the preceding claims, characterized in that it additionally comprises salt, which is present in proportions of between 0.1 and 2% by weight, preferably between 0.3 and 1.5%, and sucrose, which is present in proportions of between 0.1 and 2% by weight, preferably between 0.3 and 1.5%.

8. The composition as claimed in any one of the preceding claims, characterized in that it comprises a flavoring agent, which is present in proportions of between 0.05% and 1.5% by weight, preferably between 0.2 and 1%.

9. The composition as claimed in any one of the preceding claims, characterized in that it additionally comprises a taste enhancer, which is present in proportions of between 0.1 and 3%, preferably between 0.3 and 2% by weight.

10. The use of the composition as claimed in any one of claims 1 to 9, for coating dry domestic animal feedstuffs.

11. An animal feed product, in kit form, comprising the animal feed composition, as claimed in any one of claims 1 to 9, contained in a first container, and dry domestic animal feedstuffs, contained in a second container.
